(19) United States
(12) Patent Application Publication
(10) Pub. No.: US 2010/0135914 A1
(43) Pub. Date: Jun. 3, 2010

(54) AZEOTROPIC FUMIGANT COMPOSITIONS AND METHODS OF CONTROLLING PESTS

(76) Inventors: Andrew Joseph Poss, Kenmore, NY (US); Rajiv Ratna Singh, Getzville, NY (US); Hang T. Pham, Amherst, NY (US)

Correspondence Address: HONEYWELL/DLA PIPER;Patent Services, 101 Columbia Road, P.O.Box 2245, Morristown, NJ, 07962, US

(21) Appl. No.: 12/327,262

(22) Filed: Dec. 3, 2008

(51) Int. Cl. A01N 25/32; A01N 59/12

(52) U.S. Cl. 424/10.4; 424/669

(57) ABSTRACT

A fumigant composition including an azeotropic mixture of methyl iodide and sulfuryl fluoride; and a method of controlling at least one target insect species including treating a target space with a composition including an azeotropic mixture of methyl iodide and sulfuryl fluoride by applying an amount of the composition to the target space that is effective to kill a substantial portion of the target insect species in multiple development stages.

### TECHNICAL FIELD

This disclosure relates to chemical compositions for post harvest and quarantine treatments, structures and fumigating soil, and methods of pest control.

### BACKGROUND

Sulfuryl fluoride (sometimes hereinafter referred to as SO₂F₂ or SF) was developed in the late 1950's as a structural fumigant, mainly for termite control as disclosed by Steward in Journal of Economic Entomology 50, 7 (1956) and U.S. Pat. No. 2,875,127. It has been registered and marketed since 1961 by Dow AgroSciences under the trade name Vikane® for control of wood and structure pests. Dow AgroSciences later introduced sulfuryl fluoride under the trade name Profume® as a methyl bromide alternative for post-harvest insect control.

Sulfuryl fluoride is a non-flammable, odorless and colorless gas (boiling point −55.2° C.). Because of the low boiling point and high vapor pressure, SF readily vaporizes under normal fumigation conditions, thus allowing rapid dispersion during dosing/application. Sulfuryl fluoride is non-corrosive. This is an important characteristic for a fumigant used in environments where sensitive equipment and electronic devices are employed. It does not react with materials to form unpleasant orders. Because of its low sorption characteristics, sulfuryl fluoride rapidly aerates from structures and commodities. Penetration in material and commodities is also fast.

Efficacy research has been conducted to define dosages and treatment practices to optimize the control of key post-harvest insect pests. Sulfuryl fluoride is highly toxic to post-embryonic stages of insects as disclosed in Kenaga, Journal of Economic Entomology 50 (1957) 1, Bond and Monro, 1961, Drinkall, 1996, and Bell, 2004, 2006. However, the eggs of many moths and beetles are difficult to control, especially at lower temperatures as disclosed by Williams and Sprenkel in J. Entomol Science 25 (1990) 366 and Bell in Journal of Stored Products Research 35 (1999) 233. The egg stage of many insects appears to be up to ten times more tolerant than adult insects, utilizing concentrations of over 50 mg/L and exposures of up to three days for complete kill as disclosed by Williams and Sprenkel, 1990.

The lethal dose for insects may be determined by factors such as: the type of insect; its stage of development; the concentration of the fumigation agent; temperature; and duration of fumigation. The longer the fumigation can last, and the higher the temperature at which the fumigation is carried out, the lower is the lethal concentration of the fumigation agent. In practice, however, there is usually an upper limit to the temperature because of energy costs or sensitive objects that should not be heated to too high a temperature. The duration of fumigation may also be limited for economic reasons. Typical exposure times with Profume® average 48-72 hours as disclosed by Thoms in Proceedings of the 8^{th} International Conference on Controlled Atmospheric and Fumigation in Stored Products, 2008, 698 and utilize dosages greater than 50 mg/L.

Methyl iodide has been a registered fumigant by the U.S. Environmental Protection Agency (EPA) since 2007. It is marketed by Arysta LifeSciences as MIDAS®, a broad-spectrum soil fumigant to control a broad range of soil-borne diseases, nematodes, weeds seeds and insects that threaten high-value crops. Zhang [Pestic. Sci. 53 (1998) 71-79] and U.S. Pat. No. 5,518,692 disclose the use of methyl iodide as a soil fumigant and U.S. Pat. No. 5,753,183 employs methyl iodide as a structural fumigant. WO 2006/028293 describes a mixture of methyl, iodide and carbon dioxide for wood fumigation.

Methyl iodide occurs as a colorless nonflammable liquid with a pungent odor and a boiling point of 42.4° C. The chemical formula for methyl iodide is CH₃I, and its molecular weight is 141.95 g/mol. The vapor pressure for methyl iodide is 400 mm Hg at 25° C., and the chemical turns brown on exposure to light.

The egg and pupa stages of stored-products insects are generally more tolerant than larvae or adults to the fumigants as reported with phosphine, methyl bromide and carbonyl sulphide. Faruki (Journal of Applied Entomology 129 (2005) 12) discloses that methyl iodide is toxic to all life stages of the maize weevil at relatively short exposure periods and low temperatures. Faruki also discloses that eggs and larvae were threefold more susceptible than adults and pupae at the exposure limits. Methyl iodide was shown to be toxic to the maize weevil eggs at dosage levels of 2.16 mg/L over 6 hours.

Sulfuryl fluoride utilizes very high concentrations and raised temperatures to control stored-product insect eggs. U.S. Pat. No. 6,921,454 discloses that a combination of sulfuryl fluoride with an ovicidal gas, (i.e., a chemical agent that kills eggs) can fumigate all stages of insect life including eggs under sublethal conditions relative to the ovicide gas and sulfuryl fluoride. Suitable ovicides reported include hydrocyanic acid, alkyl formats, alkyl isothiocyanates, nitrites, carbonyl sulfide or hydrogen phosphide.

That method has a serious problem in that each of these ovicide gases forms a zeotropic blend with sulfuryl fluoride. A zeotropic blend combines component fumigants of different volatilities or boiling points that, when released from application cylinders, change in volumetric composition. As the cylinder is vented, the more volatile component boils off first, changing the composition (mole fraction) of the remaining liquid. The composition of the fumigant gas also differs since it is initially composed of only the lowest boiling component fumigant. As the cylinder empties, the less volatile components eventually boil off and the composition of the gas fumigant is high in the higher boiling component. The immediate consequence of the boiling point differences between the two fumigant components is that the composition of the gas used when the cylinder is first opened is not the same as that of the gas as the cylinder empties. Thus, the change in composition with application causes non-uniform component fumigant application and poor efficacy.

### SUMMARY

We provide a fumigant composition comprising an azeotropic mixture of methyl iodide and sulfuryl fluoride.

We also provide a fumigant composition that kills at least one target insect species in various development stages comprising an azeotropic mixture comprising about 3 to about 10 wt % methyl iodide, about 90 to about 97 wt % sulfuryl fluoride and about 0.1 to about 5 wt % of a stabilizer, based on the weight of methyl iodide.

We further provide a method of controlling at least one target insect species comprising contacting a target space containing the at least one target insect species in multiple developmental stages with a composition comprising an azeotropic mixture of methyl iodide and sulfuryl fluoride at a concentration that is effective to kill a substantial portion of the target insect species in multiple development stages.

### DETAILED DESCRIPTION

We discovered that methyl iodide and sulfuryl fluoride form an azeotropic mixture. We also discovered that the azeotropic fumigant blend behaves as a pure fluid. Thus, the composition (mole fraction) of the fumigant gas (the azeotropic blend) and the liquid in the azeotropic fumigant blend remain unchanged throughout the complete process of venting the cylinder or container in which it resides. Therefore, the composition of the mixed fumigant gas remains substantially uniform during fumigant application and efficacy results are substantially the same over the entire application area.

Methyl iodide forms a minimum boiling azeotrope with sulfuryl fluoride. The azeotrope composition exists at about 0.5 to about 30 wt % methyl iodide. The boiling point of the mixture is about −59.6° C. at 14.24 Psia. The system becomes two phases at a composition of about 25 wt % methyl iodide: at −60° C. Phase separation may increase in the composition as the temperature increases. The azeotrope has a boiling point about 0.3 degrees lower than pure sulfuryl fluoride. Therefore, the azeotropic mixture of methyl iodide and sulfuryl fluoride can be packaged and handled with the same equipment as currently accepted for sulfuryl fluoride fumigation.

Methyl iodide is relatively more toxic to eggs and less toxic to adults or other post-egg stages. Sulfuryl fluoride is quite toxic to the active life stages of insects and somewhat ineffective on insect eggs. The sulfuryl fluoride portion of the azeotropic fumigant can thus be used in a concentration which is lethal to developed stages of the insect (larva, pupa, adult and the like) and sublethal with respect to the extermination of insect eggs. At the same time, the concentration of methyl iodide will be such as to be lethal to the insect egg stage. Such an azeotrope should thus be composed of about 3 to about 10 wt % methyl iodide and about 90 to about 97 wt % sulfuryl fluoride, based on the weight of the azeotrope. This permits treatment of structures at concentrations of about 2.2 mg/L methyl iodide and about 34 mg/L sulfuryl fluoride. The preferred range of concentrations is about 1 to about 4 mg/L of methyl iodide and about 30 to about 40 mg/L of sulfuryl fluoride.

This mixture includes enough methyl iodide to kill the eggs and at the same time enough sulfuryl fluoride to kill the other development stages of the insect. The concentration of sulfuryl fluoride is sublethal to insect eggs, but the presence of methyl iodide compensates for this sublethality and reduces the required exposure time for complete kill. “Complete kill” means that application or treatment with the azeotrope kills or inactivates a large portion of at least one target insect, in multiple life stages, without necessarily killing or inactivating every single insect, in every life stage, in the target space. Thus, the use of the sulfuryl fluoride/methyl iodide azeotrope to fumigate target spaces such as foodstuffs, soil or the like, residential and commercial structures, factories, mills, warehouses, storage structures, transportation vehicles and the like uses less time, and can be performed at lower temperatures and lower concentrations of fumigants.

In some cases, methyl iodide can become unstable on storage. Typically for methyl iodide storage stability, copper, terpenes or other stabilizers are known and can be added to the methyl iodide/sulfuryl fluoride azeotropic blend. A preferred amount of stabilizer can be about 0.1 to about 5.0 wt %, based on the weight of the blend.

The azeotropic mixture is substantially odorless. Therefore, it can be helpful to introduce a warning agent into the mixture. Examples can include, but are not limited to, banana oil and chloropicrin. A preferred amount of warning agent can be about 0.1 to about 5.0 wt %, based on the weight of methyl iodide.

### EXAMPLE 1

An ebulliometer consisting of a vacuum jacketed tube with a condenser on top which is further equipped with a Quartz Thermometer was used. About 25.4 g sulfuryl fluoride was charged to the ebulliometer and then methyl iodide was added in small, measured increments. Temperature depression was observed when methyl iodide was added to sulfuryl fluoride, indicating that a binary minimum boiling azeotrope was formed. The atmospheric pressure was measured to be 14.24 psia. From greater than about 0 to about 10 weight percent methyl iodide, the boiling point of the composition changed by about 0.3° C. or less. The binary mixtures shown in Table 1 were studied and the boiling point of the compositions from 10 wt % to about 30 wt % methyl iodide changed by less than about 0.5° C. The compositions exhibit azeotrope and/or azeotrope-like properties over this range.

TABLE 1

| Wt. % CH3I | Wt. % SO2F2 | | T (C.) |
|---|---|---|---|
| 0.00 | 100.00 | | −55.28 |
| 0.45 | 99.55 | | −55.37 |
| 1.33 | 98.67 | | −55.54 |
| 3.05 | 96.95 | | −55.59 |
| 4.71 | 95.29 | | −55.59 |
| 6.31 | 93.69 | | −55.59 |
| 10.10 | 89.90 | | −55.58 |
| 14.26 | 85.74 | | −55.56 |
| 19.23 | 80.77 | | −55.55 |
| 23.67 | 76.33 | <--- 2 phases | −55.51 |
| 27.64 | 72.36 | SS Cloudy | −55.51 |
| 31.64 | 68.36 | | −55.51 |

### EXAMPLE 2

This example relates to a structural fumigation process. Prior to structural fumigation, all open flames and glowing heat filaments are turned off or disconnected. Methyl iodide and sulfuryl fluoride are combined to form an azeotropic composition. The composition is applied as a fumigant to tarped or sealed structures for an exposure period selected to rid the structure of deleterious organisms, followed by an aeration period long enough to flush unused fumigant and any warning gas from the structure. Because the methyl iodide/sulfuryl fluoride mixture is odorless and does not irritate eyes or skin, trace amounts of a warning agent (e.g., chloropicrin) are introduced into the structure prior to fumigation. The required dosage of the fumigant is influenced by the temperature at the site of the pest, the length of the exposure period, containment or the rate the fumigant is lost from the structure, and the susceptibility of the pest to be controlled.

### EXAMPLE 3

Sulfuryl fluoride and methyl iodide azeotrope can be employed for the fumigation of corn, wheat, milo, oats and the like. In these operations, one of the above cereal grains, infested with insects, is exposed to the vapors of the toxicant for a period long enough to kill all developmental stages of the insects. Following the fumigation operation, the grain is aerated long enough to remove residue fumigant.

Thus, our composition and methods are effective in controlling a variety of pests and insects such as, but not limited to, sawtooth grain beetle (O. surinamensis), lesser grain borer (R. dominica), rice weevil (S. oryzae), red flour beetle (T. castaneum), coding moth (cyclia pomonella), confused flour beetle (tribolium confusum), pine wood nematode, longhorn beetle, wood fungi (C. fagacearu), red scale (Aonidiella aurantii), grain moths (sitotroga), maize weevil (S. zeamais), lyctid beetle eggs, aphid mummies and mealybug.

Although the compositions and methods have been described in connection with specific forms thereof, it will be appreciated that a wide variety of equivalents may be substituted for the specified elements described herein without departing from the spirit and scope of this disclosure as described in the appended claims.

1. A fumigant composition comprising an azeotropic mixture of methyl iodide and sulfuryl fluoride.

2. The composition according to claim 1, further comprising a stabilizer.

3. The composition according to claim 1, further comprising a warning agent.

4. The composition according to claim 1, comprising about 3 to about 10 wt % methyl iodide and about 90 to about 97 wt % sulfuryl fluoride based on the weight of the mixture.

5. The composition according to claim 1, wherein the azeotropic mixture contains a proportional amount of methyl iodide that is lethal to eggs of at least one target insect and sublethal to other development stages of the target insect, and sulfuryl fluoride that is lethal to the other development stages of the target insect and sublethal to the insect eggs.

6. A fumigant composition that kills at least one target insect species in various development stages comprising an azeotropic mixture comprising about 3 to about 10 wt % methyl iodide, about 90 to about 97 wt % sulfuryl fluoride and about 0.1 to about 5.0 wt % of a stabilizer, based on the weight of the methyl iodide.

7. The composition according to claim 6, further comprising a warning agent.

8. The composition according to claim 7, wherein the warning agent is chloropicrin or banana oil.

9. The composition according to claim 6, wherein the stabilizer is a terpene or metallic copper.

10. The composition according to claim 6, wherein the azeotropic mixture contains a proportional amount of methyl iodide that is lethal to eggs of at least one-target insect and sublethal to other development stages of the target insect, and sulfuryl fluoride that is lethal to the other development stages of the target insect and sublethal to the insect eggs.

11. A method of controlling at least one target insect species comprising contacting a target space containing the at least one target insect species in multiple developmental stages with a composition comprising an azeotropic mixture of methyl iodide and sulfuryl fluoride at a concentration that is effective to kill a substantial portion of the target insect species.

12. The method according to claim 11, wherein the composition further comprises a stabilizer.

13. The method according to claim 11, wherein the composition further comprises a warning agent.

14. The method according to claim 11, wherein the composition comprises about 3 to about 10 wt % methyl iodide and about 90 to about 97 wt % sulfuryl fluoride, based on the weight of the composition.

15. The method according to claim 12, wherein the stabilizer is a terpene or metallic copper.

16. The method according to claim 13, wherein the warning agent is chloropicrin or banana oil.

17. The method according to claim 11, wherein the multiple development stages comprises egg, larva, pupa and adult.

18. The method according to claim 11, wherein the target insect species is at least one selected from the group consisting of sawtooth grain beetle (O. surinamensis), lesser grain borer (R. dominica), rice weevil (S. oryzae), red flour beetle (T. castaneum), coding moth (cyclia pomonella), confused flour beetle (tribolium confusum), pine wood nematode, longhorn beetle, wood fungi (C. fagacearu), red scale (Aonidiella aurantii), grain moths (sitotroga), maize weevil (S. zeamais), lyctid beetle eggs, aphid mummies and mealybug.

19. The method according to claim 11, wherein the target space is at least one selected from the group consisting of vehicles, storage structures, foodstuffs, soils, residential structures, commercial structures and factories.

20. The method according to claim 11, wherein the concentration is about 1 to about 4 mg/L of methyl iodide and about 30 to about 40 mg/L of sulfuryl fluoride.
